(19) United States
(12) Patent Application Publication
(10) Pub. No.: US 2026/0102894 A1
(43) Pub. Date: Apr. 16, 2026

(54) POWER TOOL INCLUDING AN INTERNAL AUXILIARY POWER SUPPLY

(71) Applicant: MILWAUKEE ELECTRIC TOOL CORPORATION, Brookfield, WI (US)

(72) Inventors: Daniel M. Blau, Milwaukee, WI (US); Kerry J. Woodbury, Port Washington, WI (US); Zoltan Polik, Menomonee Falls, WI (US); James J. Wekwert, Whitefish Bay, WI (US)

(21) Appl. No.: 19/352,710

(22) Filed: Oct. 8, 2025

Related U.S. Application Data
(60) Provisional application No. 63/706,910, filed on Oct. 14, 2024.

(51) Int. Cl. B25F 5/02; H01M 50/247

(52) U.S. Cl. CPC B25F 5/02; H01M 50/247; H01M 2220/30

(57) ABSTRACT

A power tool including a power tool housing, an interface configured to receive a battery pack, an internal energy storage circuit located within the power tool housing, a trigger for user control of power tool operation, a plurality of switches configured to connect the battery pack and the internal energy storage circuit in series or parallel, and a controller. The controller is configured to receive a control signal from the trigger, control the power tool based on the control signal, control the plurality of switches to set a power source configuration of the power tool by selectively connecting the battery pack, the internal energy storage circuit, or both the battery pack and the internal energy storage circuit to a load of the power tool, and provide energy to the load of the power tool according to the power source configuration.

### RELATED APPLICATIONS

This application claims the benefit of U.S. Provisional Patent Application No. 63/706,910, filed Oct. 14, 2024, and the entire content of which is hereby incorporated by reference.

### FIELD

Embodiments described herein relate to battery pack powered power tools.

### BACKGROUND

Electric power tools receive power from a power source to drive a load. Some electric power tools are corded to receive power from an external power source, such as a power outlet positioned in a wall. Other electric power tools receive power from a battery pack.

Battery-powered power tools allow for increased portability and convenience by eliminating the need for the electric cord anchored to the external power source.

### SUMMARY

Power tools described herein include a power tool housing, an interface configured to receive a battery pack, an internal energy storage circuit located within the power tool housing, a trigger for user control of power tool operation, a plurality of switches configured to connect the battery pack and the internal energy storage circuit in series or parallel, and a controller. The controller is configured to receive a control signal from the trigger, control the power tool based on the control signal, control the plurality of switches to set a power source configuration of the power tool by selectively connecting the battery pack, the internal energy storage circuit, or both the battery pack and the internal energy storage circuit to a load of the power tool, and provide energy to the load of the power tool according to the power source configuration.

Electrical devices described herein include an internal energy storage circuit, a plurality of switches configured to connect a battery pack and the internal energy storage circuit in series or parallel, and a controller. The controller is configured to control the plurality of switches to set a power source configuration of a power tool by selectively connecting the battery pack, the internal energy storage circuit, or both the battery pack and the internal energy storage circuit to a load of the power tool. The controller is configured to provide energy to the load of the power tool according to the power source configuration.

Methods of providing auxiliary power to a battery pack powered power tool based on operation parameters of the power tool described herein include controlling, via a controller of the power tool, a plurality of switches to connect a battery pack and an internal energy storage circuit of a power tool in series or parallel. The methods also include controlling, via the controller, the plurality of switches to set a power source configuration of the power tool by selectively connecting the battery pack, the internal energy storage circuit, or both the battery pack and the internal energy storage circuit to a load of the power tool, and providing, via the power source configuration, energy to the load of the power tool.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one. ” Rather these articles should be interpreted as meaning “at least one” or “one or more. ” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only.

Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the invention will become apparent by consideration of the detailed description and accompanying drawings.

### BRIEF DESCRIPTION OF THE DRAWINGS

FIG. 1 illustrates an example of a battery pack powered power tool including an internal energy storage circuit.

FIG. 2 shows an example controller for the power tool of FIG. 1.

FIG. 3 shows an example application of an internal energy storage circuit.

FIG. 4 shows an example application of the internal energy storage circuit.

FIG. 5 shows an example application of the internal energy storage circuit.

FIG. 6 shows an example application of the internal energy storage circuit.

FIG. 7 shows an example application of the internal energy storage circuit.

FIG. 8 shows an example application of the internal energy storage circuit.

FIG. 9 shows an example application of the internal energy storage circuit.

FIG. 10A shows an example application of the internal energy storage circuit.

FIG. 10B shows an example application of the internal energy storage circuit.

FIG. 11 shows an example application of the internal energy storage circuit.

FIG. 12 shows an example application of the internal energy storage circuit.

FIG. 13A shows an example internal energy storage circuit including a single energy storage unit and a boost converter.

FIG. 13B shows an example internal energy storage circuit including a plurality of energy storage units.

FIG. 14A shows an example internal energy storage circuit wherein the internal energy storage circuit includes a capacitor configured to be connected in series with a battery pack to power a load.

FIG. 14B shows an example internal energy storage circuit wherein the internal energy storage circuit includes a capacitor configured to be connected in series with a battery pack to power a load.

FIG. 15A shows an example internal energy storage circuit wherein the internal energy storage circuit includes a battery configured to be connected in series with the battery pack to power a load.

FIG. 15B shows an example internal energy storage circuit wherein the internal energy storage circuit includes a battery configured to be connected in series with the battery pack to power a load.

FIG. 16A shows an example internal energy storage circuit wherein the internal energy storage circuit includes a capacitor configured to be connected in parallel with the battery pack to power a load.

FIG. 16B shows an example internal energy storage circuit wherein the internal energy storage circuit includes a capacitor configured to be connected in parallel with the battery pack to power a load.

FIG. 16C shows an example internal energy storage circuit wherein the internal energy storage circuit includes a capacitor configured to be connected in parallel with the battery pack to power a load.

FIG. 17A shows an example internal energy storage circuit wherein the internal energy storage circuit includes a battery configured to be connected in parallel with the battery pack to power a load.

FIG. 17B shows an example internal energy storage circuit wherein the internal energy storage circuit includes a battery configured to be connected in parallel with the battery pack to power a load.

FIG. 17C shows an example internal energy storage circuit wherein the internal energy storage circuit includes a battery configured to be connected in parallel with the battery pack to power a load.

FIG. 18 is a flowchart illustrating an example control method for providing auxiliary power to a battery-powered power tool.

### DETAILED DESCRIPTION

Some electric power tools receive power from a battery pack to drive a load. Battery pack powered power tools allow for increased portability and convenience by eliminating the need for an electric cord. However, in high-power-demand applications, users often face different experiences when using different battery packs. Low-power packs may not be able to deliver enough current to complete a demanding application for a high-power tool (e.g., circular saws, chainsaws, etc.). Low current delivery can lead to slower application time, tool bogging during application, or overheating battery packs (for example, due to the high demand on the pack). Using a high-power battery pack in demanding applications can lead to terminal overheating, power electronics overheating, and/or motor overheating. User experience may be improved by an additional, in-tool energy storage device (e.g., a battery cell, a capacitor, etc., located within a housing of the tool) that can be controlled in different ways to overcome the issues described above by providing auxiliary power to a power tool motor in various applications, in addition to power provided by a battery pack.

Embodiments described herein relate to an internal energy storage circuit for a power tool that is selectively controlled to provide auxiliary power to the power tool. The auxiliary power may be used to supplement power provided by a battery pack or may be used as the sole source of power for the power tool. Thus, in some embodiments, the internal energy storage circuit enables the power tool to continue to operate when executing tasks that require more power than otherwise available from battery pack cells alone. Further, in some embodiments, the internal energy storage circuit selectively provides power to the motor, which supplements power provided by the battery pack, thereby reducing the power burden on the battery pack. In other embodiments, the internal energy circuit alone is used to provide power to the power tool motor, such as when a battery pack of the power tool is hot swapped during operation, or when attaching the battery pack would make the power tool too unwieldy for the task to be performed.

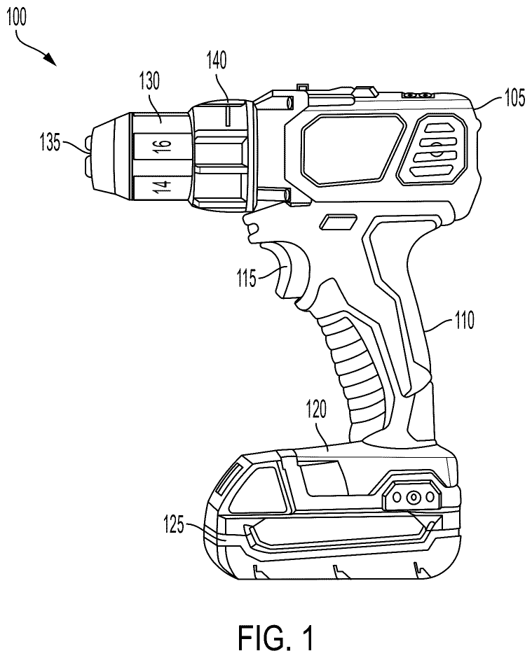

FIG. 1 illustrates an example of a battery pack powered power tool 100 including an internal energy storage circuit. In this example, the power tool 100 is a hammer drill-driver and may be referred to as a hammer drill. The power tool 100 includes a tool housing 105, a handle 110, a trigger 115, a base 120, and a battery pack 125. In some embodiments, the battery pack 125 may be a rechargeable battery pack including a battery pack housing that is removably coupled to the base 120. The battery pack housing houses a plurality of battery cells and a battery controller configured to control the charging and discharging of the battery cells (e.g., via power switching elements). The plurality of battery cells may be lithium ion (“Li-ion”) cells, Nickel-Cadmium (“Ni-Cad”) cells, or cells of another chemistry type. Collectively, the cells may provide nominal output voltages of different values, including but not limited to 4V, 12V, 18V, 28V, 36V, 40V, 80V, 120V, etc. In other embodiments, the battery pack 125 may be integrated within the housing 105 of the power tool 100.

The power tool 100 receives power from the battery pack 125 and drives an output shaft 130 having a tool bit receiver 135 (e.g., a chuck). The tool bit receiver 135 is configured to receive a driver bit that drives a screw into a work material, a drill bit that drills a hole into a work material, or another tool bit. In various embodiments, different types of tool bits may be inserted into the tool bit receiver 135 depending on properties of the work material and the desired task. A mode selector 140 is positioned on the housing 105 and allows a user to select a desired operation mode of the power tool 100 (e.g., drill, hammer drill, or drive at a particular clutch setting). In the present embodiment, the mode selector 140 is configured as a ring selector that allows the user to rotationally select the desired operation mode. In other embodiments, the mode selector 140 may be configured to select operating modes or applications for the internal energy storage circuit. In some embodiments, the mode selector 140 may be another type of user interface, such as a user interface having buttons, switches, or electronic displays such as touchscreens.

Although, the example power tool 100 is shown as a hammer drill, the power tool 100 may be any motorized power tool that is battery pack powered and that drives an output shaft (e.g., chuck, saw blade holder, or arbor). Such power tools include, for example, impact wrenches, impact drivers, nailers, reciprocating saws, circular saws, table saws, cutters, drill-drivers, hammers, grinders, and the like.

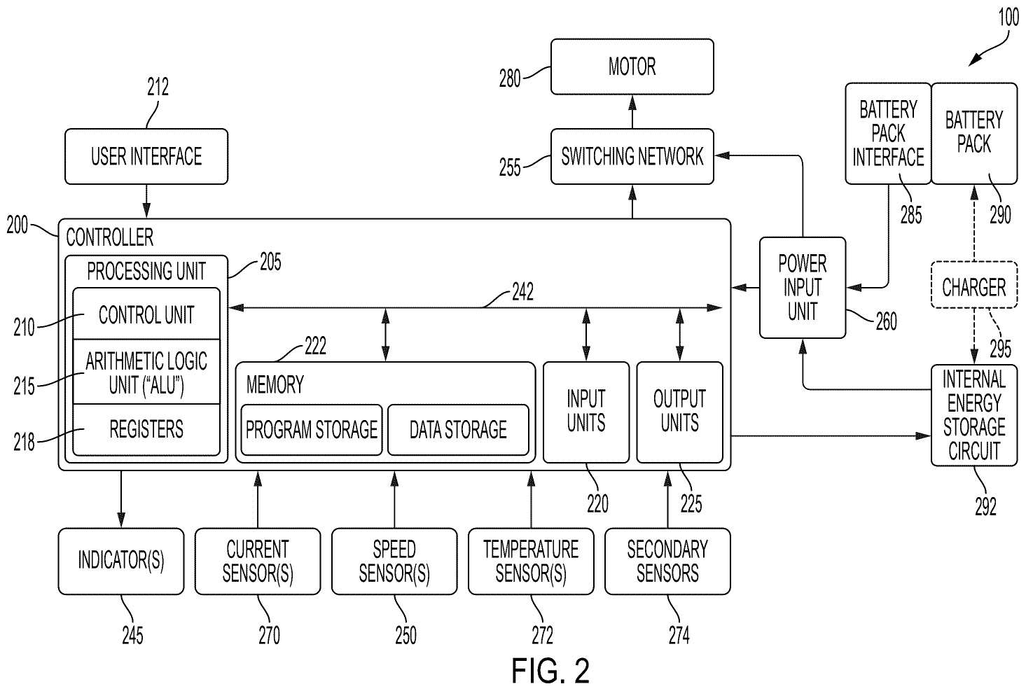

FIG. 2 shows a controller 200 for the power tool 100. The controller 200 is electrically and/or communicatively connected to a variety of modules or components of the power tool 100. For example, the illustrated controller 200 is connected to indicators 245, current sensor(s) 270, speed sensor(s) 250, temperature sensor(s) 272, secondary sensor(s) 274 (e.g., a voltage sensor, an accelerometer, a torque sensor or torque transducer, etc.), the user interface 212 (e.g., mode selector 140), a power switching network 255, a power input unit 260, and a motor 280.

The controller 200 includes a plurality of electrical and electronic components that provide power, operational control, and protection to the components and modules within the controller 200 and/or power tool 100. For example, the controller 200 includes, among other things, a processing unit 205 (e.g., a microprocessor, an electronic processor, an electronic controller, a microcontroller, or another suitable programmable device), a memory 222, input units 220, and output units 225. The processing unit 205 includes, among other things, a control unit 210, an arithmetic logic unit (“ALU”) 215, and a plurality of registers 218 and is implemented using a known computer architecture (e.g., a modified Harvard architecture, a von Neumann architecture, etc.). The processing unit 205, the memory 222, the input units 220, and the output units 225, as well as the various modules connected to the controller 200 are connected by one or more control and/or data buses (e.g., common bus 242). The use of one or more control and/or data buses for the interconnection between and communication among the various modules and components would be known to a person skilled in the art in view of the embodiments described herein.

The memory 222 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 222 and executes software instructions that are capable of being stored in a RAM of the memory 222 (e.g., during execution), a ROM of the memory 222 (e.g., on a generally permanent basis), or another non-transitory computer readable medium such as another memory or a disc. Software included in the implementation of the power tool 100 can be stored in the memory 222 of the controller 200. The software includes, for example, firmware, one or more applications, program data, filters, rules, one or more program modules, and other executable instructions. The controller 200 is configured to retrieve from the memory 222 and execute, among other things, instructions related to the control processes and methods described herein. In other embodiments, the controller 200 includes additional, fewer, or different components.

The controller 200 drives the motor 280 to rotate an output (e.g., a driver) in response to a user's manipulation of the user interface 212 (e.g., depressing trigger 115). The output may be coupled to the motor 280 via an output shaft. Manipulation of the user interface 212 may cause power to be drawn from battery pack 290 (e.g., battery pack 125), to drive the motor 280 at a specific speed and in a specific direction. In some embodiments, the controller 200 controls the power switching network 255 (e.g., a FET switching bridge) to drive the motor 280. The power switching network 255 may include, for example, a plurality of high side switching elements (e.g., FETs) and a plurality of low side switching elements (e.g., FETs). The controller 200 may control each switch of the plurality of high side switching elements and the plurality of low side switching elements to drive each phase of the motor 280. For example, the power switching network 255 may be controlled to more quickly decelerate the motor 280. In some embodiments, the controller 200 monitors a rotation of the motor 280 (e.g., a rotational rate of the motor 280, a velocity of the motor 280, a position of the motor 280, a rotational direction of the motor 280, and the like) via the speed sensors 250.

The indicators 245 are also connected to the controller 200 and receive control signals from the controller 200 to turn on and off or otherwise convey information based on different states of the power tool 100. The indicators 245 include, for example, one or more light-emitting diodes (“LEDs”) and/or a display screen (e.g., an electronic display). The indicators 245 can be configured to display conditions of, or information associated with, the power tool 100. For example, the indicators 245 can display information relating to an operational state of the power tool 100, such as a mode or speed setting. The indicators 245 may also display information relating to a fault condition, or other abnormality of the power tool 100. In addition to or in place of visual indicators, the indicators 245 may also include a speaker or a tactile feedback mechanism to convey information to a user through audible or tactile outputs.

A battery pack interface 285 is connected to the controller 200 and is configured to couple with battery pack 290. The battery pack interface 285 includes a combination of mechanical (e.g., a battery pack receiving portion) and electrical components configured to and operable for interfacing (e.g., mechanically, electrically, and communicatively connecting) the power tool 100 with the battery packs 290. The battery pack interface 285 is coupled to the power input unit 260 and the switching network 255, and transmits the power received from the battery pack 290 to the power input unit 260 and the switching network 255. The power input unit 260 may also include active and/or passive components (e.g., voltage step-down controllers, voltage converters, inverters, rectifiers, filters, etc.) to regulate or control the power received through the battery pack interface 285 and to the controller 200. The power input unit 260 may also include switches configured to be controlled by the controller 200 to set a power source configuration of the power tool 100 by placing the internal energy storage circuit 292 in series or parallel with the battery pack 290 and a load (e.g., motor 280 or other components of the power tool 100), or to connect or disconnect the internal energy storage circuit 292 to the motor 280 or other components of the power tool 100 as required to provide appropriate power to the motor 280 and other components of the power tool 100 in accordance with the embodiments described below. Although the internal energy storage circuit 292 is often described herein as an electric device (e.g., a supercapacitor, battery cell(s), etc.), it is contemplated that the internal energy storage circuit 292 may be a mechanical or chemical energy storage device such as a flywheel, a mechanical spring, a pneumatic piston, a heat battery, etc.

The current sensor(s) 270 sense, for example, a current provided by the battery pack 290, a current provided by the internal energy storage circuit 292, a current associated with the motor 280, or a combination thereof. In some embodiments, the current sensor(s) 270 sense at least one of the phase currents of the motor 280. The current sensor 270 may be, for example, an inline phase current sensor, a pulse-width-modulation-center-sampled inverter bus current sensor, or the like. The speed sensors 250 sense a speed of the motor 280. The speed sensor 250 may include, for example, one or more Hall effect sensors. In some embodiments, the temperature sensor 272 senses a temperature of the switching network 255, the battery pack 290, the internal energy storage circuit 292, the motor 280, or a combination thereof.

In the embodiment shown, the user interface 212 includes the trigger 115 and the mode selector 140 and generates control signals in response to a user selection of an operation mode via the mode selector 140 and/or depressing the trigger 115. In some embodiments, a trigger depression sensor also serves as at least part of the user interface 212 and provides a control signal to the controller 200. The trigger depression sensor may be, for example, a potentiometer providing a varying signal (e.g., between 0-5 volts) proportionally representing the amount of trigger depression. In some embodiments, the user interface 212 may include other controlled user inputs, such as a forward/reverse selector, which generate responsive control signals, such as indicating a shifting of the forward/reverse selector, and are not exhaustively detailed herein.

The control signals from the user interface 212 are transmitted to the controller 200, which activates the switching network 255 to draw power from the battery pack 290 and drive the motor 280. By selectively enabling and disabling the switching network 255, power from the battery pack 290 is selectively applied to stator windings of the motor 280 to cause rotation of a rotor of the motor 280. The rotating rotor of the motor 280 drives the output shaft. The sensors 250, 270, 272, 274 provide motor information feedback (e.g., motor current information, motor rotational position information, motor rotational velocity information, motor temperature, etc.), which can be used by the controller 200 to drive the motor 280 and, as described in further detail below, determine whether the internal energy storage circuit 292 should be activated to provide additional power to the motor 280.

The controller 200 and other components of the power tool 100 are also electrically coupled to and receive power from the battery pack 290. In the embodiment shown, the motor 280 and internal energy storage circuit 292 are included (e.g., located) within the housing 105 of the power tool 100, while only a portion of the user interface 212 and the other components (e.g., indicators 245) are visible external to the housing 105 of the power tool 100. The internal energy storage circuit 292 is, for example, embedded into an interior wall of the housing 105 (e.g., in the handle of the power tool 100) while the trigger (e.g., trigger 115) of the user interface 212 is accessible at the exterior of the housing 105.

In the embodiment shown, the battery pack 125 includes a single battery pack. However, in some embodiments, a plurality of battery packs 125 may be connected to the power tool 100 to provide power. For example, in some embodiments, two or more separate battery packs 125 of the same voltage (e.g., two 18V battery packs) may be connected to the power tool 100 to provide power to the power tool 100. As another example, in some embodiments, two or more separate battery packs of different voltages (e.g., a 12V battery pack and an 18V battery pack) may be connected to the power tool 100 to provide power to the power tool 100.

Also shown in FIG. 2 is a battery charger 295 that is coupleable to the battery pack 290 to charge the battery cells of the battery pack 290. In some embodiments, the battery charger 295 may also be coupleable to the internal energy storage circuit 292 via the battery pack 290 to charge the internal energy storage circuit 292. For example, an electronic processor and memory included in the battery pack may execute instructions to selectively enable current to flow to the internal energy storage circuit 292 from the charger 295 via the battery pack 290. In some embodiments, the internal energy storage circuit 292 is within the charger 295, and the internal energy storage circuit 292 enables increased charging speed of the battery pack 125.

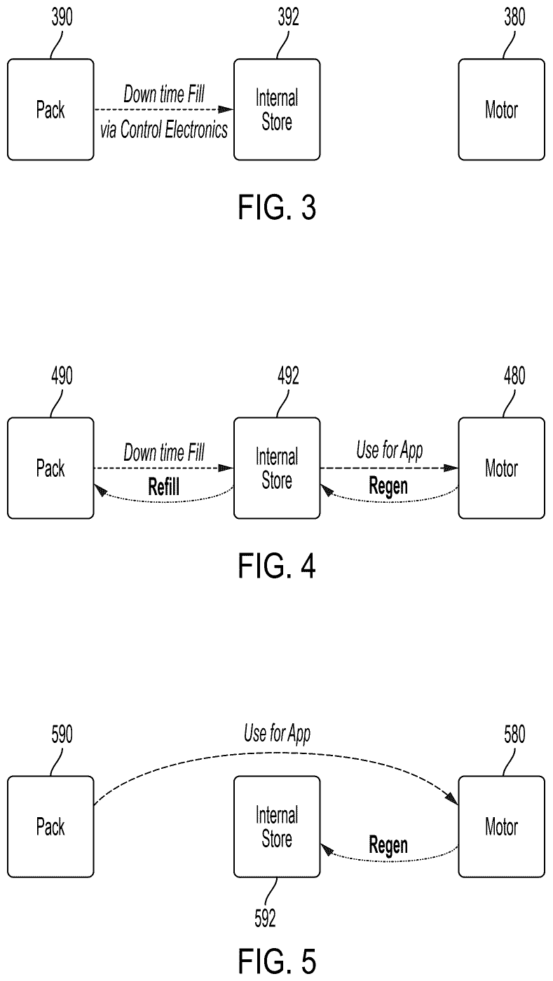

FIG. 3 shows a first application of an internal energy storage circuit 392. In the embodiment shown, a battery pack 390 is connected to the power tool 100, but the motor 380 of the power tool 100 is not being operated. In response to the battery pack 390 being connected to the power tool 100, the power tool 100 (e.g., controller 200) enables current flow from the connected battery pack 390 to the internal energy storage circuit 392 to charge the internal energy storage circuit 392. The controller 200 may also be configured to enable charging of the internal energy storage circuit 392 (via the charger 295) between operations of the power tool 100 (e.g., when the power tool 100 is idling or not being operated at all).

FIG. 4 shows a second application of an internal energy storage circuit 492. In the embodiment shown, the power tool 100 draws energy from the internal energy storage circuit 492 to drive the motor 480 of the power tool 100 and other components (e.g., the motor 480, the sensors 250, 270, 272, 274, the indicators 245, etc.). For example, the controller 200 may be configured to determine that driving a component of the power tool 100 (e.g., a light of the power tool) could be accomplished via power drawn only from the internal energy storage circuit 492. In such a case, the controller 200 may connect only the internal energy storage circuit 492 (and not the battery pack 490) to the component to provide the required power. In the embodiment shown, the controller 200 may charge the internal energy storage circuit 492 between periods of use using power drawn from the battery pack 490. Further, if the internal energy storage circuit 492 is fully charged or the efficient operation of the power tool requires it, the internal energy storage circuit 492 may be used to charge the battery pack 490. According to this application, the internal energy storage circuit 492 can be used for high-power-demand operations without placing any load on the battery pack. In some embodiments, the internal energy storage circuit 492 may also be configured to be charged via regenerative braking of the motor 480. Specifically, in response to the user interface 212 being manipulated to cease operation of the motor 280 (e.g., when the user releases the trigger 115), the momentum of the motor 480 can be used to generate current to charge the internal energy storage circuit 492 with regenerative braking. Similarly, the internal energy storage circuit 492 can be used to charge the battery pack 490.

FIG. 5 shows a third application of an internal energy storage circuit 592. In the embodiment shown, the internal energy storage circuit 592 has been depleted, for example, during operation of the motor 580 (e.g., according to the second application described above) and the power tool 100 continues to operate from power from the battery pack 590. The controller 200 may be configured to determine whether operation of the power tool 100 requires a high level of power and, based on the determination, prevent the battery pack 590 from providing power to charge the internal energy storage circuit 592. For example, if the sensors (e.g., sensors 250, 270, 272, 274) communicate a signal to the controller 200 indicating that the output shaft 130 of the power tool 100 is experiencing an amount of reverse torque exceeding a predetermined level (e.g., above 1000 foot pounds of torque), the controller 200 may, in response to the signal, prevent the battery pack 590 from charging the internal energy storage circuit 592 and instead allocate all current drawn from the battery pack 590 to driving the motor 580. As previously described, the internal energy storage circuit 592 can also be recharged using regenerative braking.

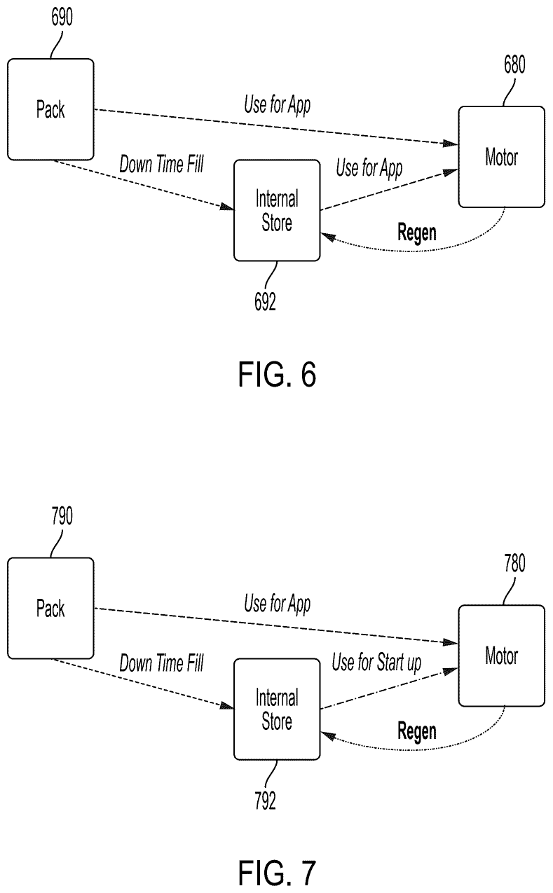

FIG. 6 shows a fourth application of an internal energy storage circuit 692. The controller 200 is configured to connect the battery pack 690 and internal energy storage circuit 692 in parallel, and to draw power from the internal energy storage circuit 692 to complete the task that requires a high power (e.g., high torque). In the embodiment shown, the controller 200 may be configured to detect (e.g., via sensors 250, 270, 272, 274) a demand (e.g., such as voltage demand or a current demand) on the battery pack 690 above a predefined threshold. In response to detecting the increased demand on the battery pack 690, the controller 200 may connect the internal energy storage circuit 692 in parallel with the battery pack 690 to provide additional power to the motor 680 such that the demand on the battery pack 690 falls below the pre-determined threshold. With this fourth application of the internal energy storage circuit 692, it is possible to complete short-time, high-power-demand tasks (e.g., finishing a cut through a tough material) in boost mode in which both the internal energy storage circuit 692 and the battery back 625 provide power to the motor 680 simultaneously in parallel. When the internal energy storage circuit 692 is depleted, the power tool 100 can run as normal from the battery pack 690. As previously described, the internal energy storage circuit 692 can also be recharged using regenerative braking or during a down time with energy from the battery pack 690.

FIG. 7 shows a fifth application of an internal energy storage circuit 792. In the embodiment shown, the motor controller 200 is configured to draw power only from the internal energy storage circuit 792 at the start of a task requiring a high starting motor current or power (in comparison to the motor current or power required for maintaining the motor speed during the performance of the task after startup). Specifically, in the embodiment shown, the internal energy storage circuit 792 alone may be used primarily for initially spinning up the motor 780 of the power tool (e.g., for starting a task, such as mixing, having a high initial torque requirement). The controller 200 may be configured to determine, based on signals from the sensors 250, 270, 272, 274, that a predetermined operation speed is achieved. In response to determining that the predetermined operation speed is achieved, the controller 200 may cause the power tool 100 to be operated solely from the battery pack 790. In some embodiments, the controller 200 may spin up the motor 280 using both the internal energy storage circuit 792 and the battery pack 790. As previously described, the internal energy storage circuit 792 can also be recharged using regenerative braking or during a down time with energy from the battery pack 790.

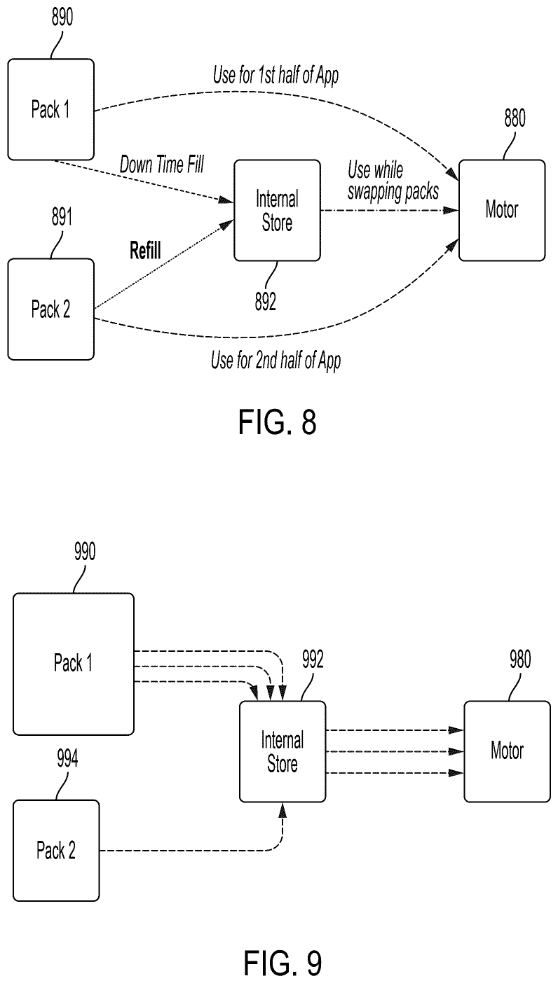

FIG. 8 shows a sixth application of an internal energy storage circuit 892. In the embodiment shown, the controller 200 is configured to drive the motor 280 using energy only from internal energy storage circuit 892 for a period during which a primary battery pack 890 has been detached from the power tool 100 and before a secondary battery pack 891 is attached to the power tool 100. Accordingly, hot swapping of the battery packs (890, 891) is enabled by use of the internal energy storage circuit 892. For example, a part of a task may be completed by using power drawn from battery pack 890, then, as the battery packs 890, 891 are swapped, the power tool 100 may continue operating on power drawn from the internal energy storage circuit. In the embodiment shown, controller 200 is configured to determine (e.g., based on signals from sensors 250, 270, 272, 274) that the primary battery pack 890 was detached from the power tool 100 during operation of the motor 880. In response to detecting that battery pack 890 was disconnected from the power tool 100, the controller 200 drives the motor 880 using power provided by the internal energy storage circuit 892. In response to the second battery pack 891 being connected to the power tool 100, the controller 200 continues operation of the motor 880 by driving the motor 880 with power drawn from the secondary battery pack 891. As previously described, the internal energy storage circuit 892 can also be recharged using regenerative braking or during a down time with energy from the battery pack 890. In some embodiments, the second battery pack 891 can also be used to recharge the internal energy storage circuit 892.

FIG. 9 shows a seventh application of an internal energy storage circuit 992. In the embodiment shown, the power tool 100 is a multi-pack power tool, and the controller 200 is configured to balance a load demand (e.g., a current draw from motor 980) between the battery packs 990, 994 using internal energy storage circuit 992. The controller 200 may be configured to balance demand placed on the battery packs 990, 994 according to their capabilities (e.g. balancing different capacity, charge, voltage, ability to provide current, age, temperature, and condition) by charging the internal energy storage circuit 992 using only one of the battery packs 990, 994 at a time, based on the to the respective maximum capabilities of the battery packs 990, 994. The controller 200 then drives the motor 280 using power drawn from the internal energy storage circuit 992.

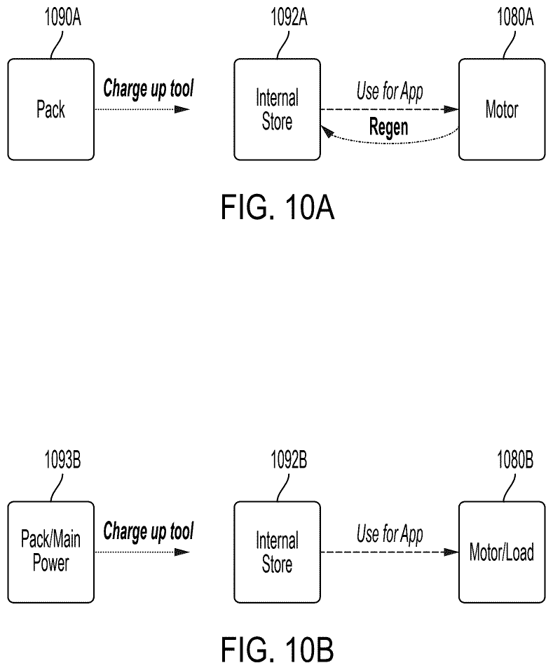

FIGS. 10A and 10B show eighth and ninth applications of the internal energy storage circuits 1092A and 1092B, respectively. In the embodiment shown in FIG. 10A, the controller 200 drives the motor 1080A of the power tool 100 using only power drawn from the internal energy storage circuit 1092A. The controller 200 is configured to sense (e.g., via sensors 250, 270, 272, 274) that a condition of the battery pack 1090A renders it unable to or unfit to provide sufficient power to the motor 1080A (e.g. due to high-temperature, over-voltage, over-current, cell damage, etc.). In response to determining that the battery pack 1090A is unable or unfit to provide power to the motor 280, the controller 200 stops drawing power from the battery pack 1090A to power the motor 1080A, and draws power from the internal energy storage circuit 1092A to drive the motor 280 instead. In the embodiment shown in FIG. 10B, the controller 200 is configured to sense (e.g., via sensors 250, 270, 272, 274) that a condition of a main power supply 1093B renders it unable to or unfit to provide sufficient power to the motor 1080B (e.g. due to high-temperature, over-voltage, over-current, power outage, etc.). In response to determining that the mains power supply 1093B is unable or unfit to provide power to the motor 280, the controller 200 stops drawing power from the main power supply 1093B to power the motor 1080B, and instead draws power from the internal energy storage circuit 1092B to drive the motor 1080B. In some embodiments, the internal energy storage circuit 1092B is used to power non-moving components (e.g., emergency egress lighting, lighting around tool stations, or other components), and regenerative braking would be unavailable.

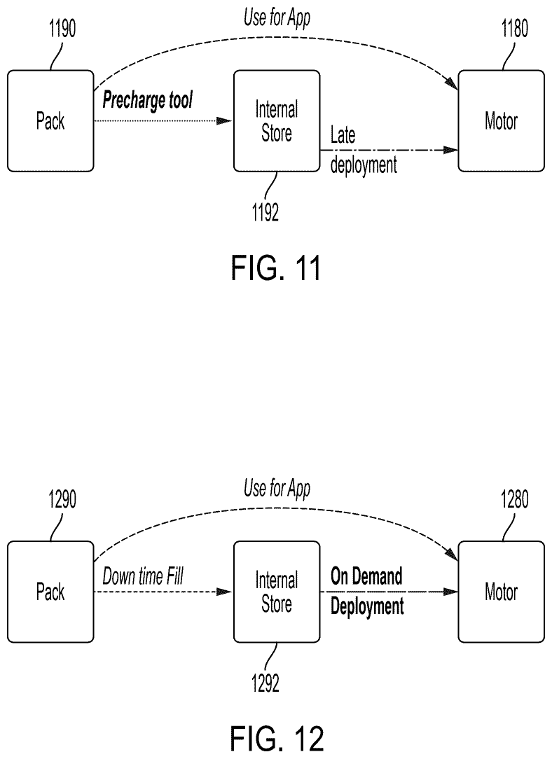

FIG. 11 shows a tenth application of an internal energy storage circuit 1192. In the embodiment shown, the voltage of the battery pack 1190 decreases in a non-linear manner as the battery pack 1190 is depleted during operation of the power tool 100. The controller 200 is configured to detect when the voltage of the battery pack 1190 drops below the predefined threshold and in response enable the motor 1180 to draw power from the internal energy storage circuit 1192. This results in a relatively constant operation voltage for the power tool 100 during a comparatively lengthy operation of the power tool 100. Using the internal energy storage circuit 1192 in this way may also help to stabilize the operation voltage of the motor 1180, resulting in a substantially regular motor speed. In some embodiments where a second battery pack (e.g., battery pack 994) is connected to the power tool 100, the controller 200 connects the secondary battery pack to the load so that energy from the secondary battery pack drives the motor 1180 when the voltage of the primary battery pack 1190 drops below a predefined threshold. Additionally, energy from the internal energy storage circuit 1192 may be used to drive the motor 1180 when the voltage of the battery pack 1190 drops below the predefined threshold during high-power-demand operations. The internal energy storage circuit 1192 can be charged by the battery pack 1190.

FIG. 12 shows an eleventh application of an internal energy storage circuit 1292. Short momentary spikes in the demand on the motor 1280 and battery pack 1290 during operations on a varying load may cause the power tool 100 to operate in an inefficient manner. In the embodiment shown, the controller 200 may be configured to detect (e.g., via sensors 250, 270, 274) a demand (e.g., a voltage demand or a current demand) on the battery pack 1290 above a predefined threshold (e.g., a voltage threshold or a current threshold). In response to detecting the increased demand on the battery pack 1290, the controller 200 may cause the internal energy storage circuit 1292 to provide additional power to the motor 1280 (e.g., by connecting the internal energy storage circuit 1292 in series or parallel with the battery pack 1290) such that the demand on the battery pack 1290 falls below the pre-determined threshold. Preventing excess demand on the battery pack 1290 in this way limits the current through the battery pack 1290 and the terminals (e.g., in battery pack interface 285), and therefore limits excess heat generation. This manner of drawing additional power from the internal energy storage circuit 1292 may also help lower performance battery packs complete high-power-demand applications or overcome bind up conditions during operation of the power tool 100. In the embodiment shown, the controller 200 is configured to disconnect the internal energy storage circuit 1292 from the motor 1280 when the demand on the battery pack 1290 drops below the predetermined threshold. The internal energy storage circuit 1192 can be charged by the battery pack 1190.

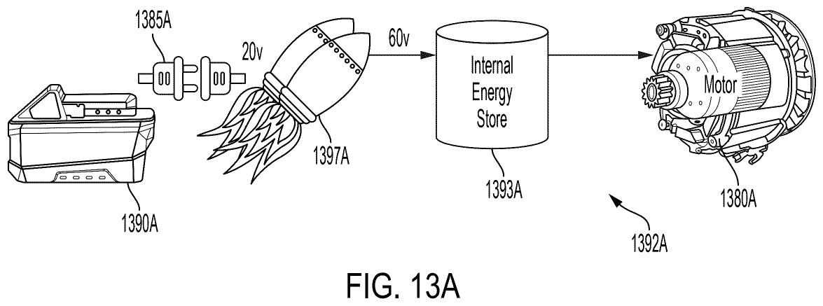

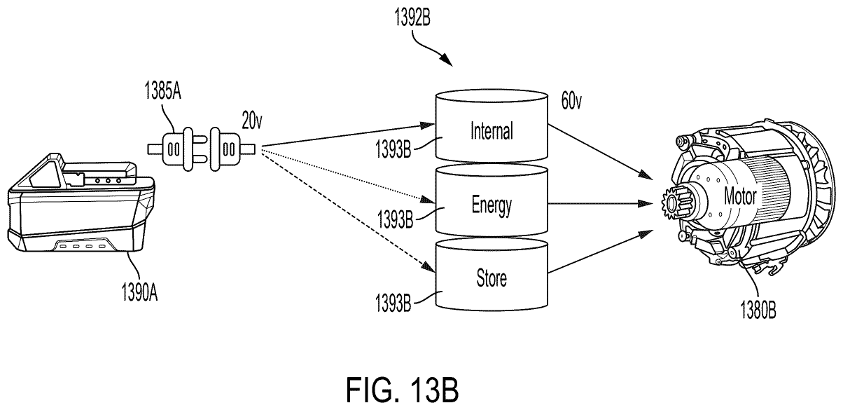

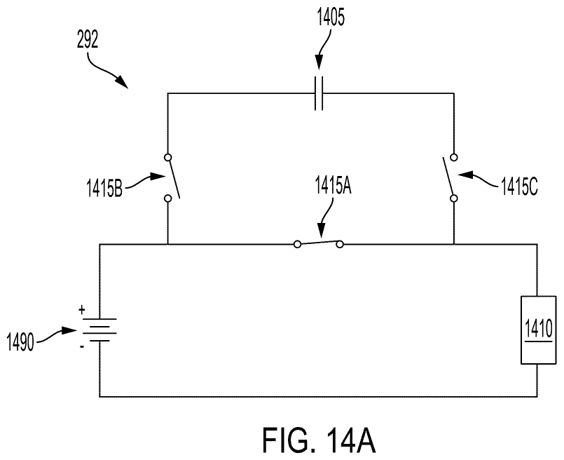

FIG. 13A and FIG. 13B show different embodiments of the internal energy storage circuits 1392A and 1392B, respectively. The internal energy storage circuit 1392A, 1392B is a high-voltage capacitor or electrochemical device (e.g., a supercapacitor or a battery) and can operate at a voltage that is higher than the rated voltage of the battery pack 1390A, 1390B. This allows the battery pack 1390A, 1390B to be configured for virtually any tool or application. In FIG. 13A, the internal energy storage circuit 1392B includes an energy storage unit 1393A (e.g., a single capacitor, a single battery cell, etc.) configured to be charged from the battery pack 1390A via terminals 1385A and a boost converter 1397A and to provide power to the motor 1380A. In FIG. 13B, the internal energy storage circuit 1392B includes a cluster of energy storage units 1393B that are configured to be connected sequentially to a power source (e.g., using switches) in a controlled manner for charging, but may be placed in series or parallel with the battery pack 1390B for discharging (e.g., to drive the motor 1380B of the power tool 100). In some embodiments, the cluster of energy storage units 1393B are configured to be charged sequentially from the battery pack 1390B via terminals 1385B and a boost converter and to provide power to the motor 1380B.

In some embodiments, the first through eleventh applications of the internal energy storage circuit 292 (described above) may be selected by a user of the power tool via the mode selector 140. For example, if the user is using the power tool 100 to perform a mixing operation (e.g., starting a concrete mix) having a high-power-demand startup period, the user may select the fifth application of the internal energy storage circuit 292 via the mode selector 140 of the power tool. The other applications of the internal energy storage circuit 1292 may also be selected by users for various purposes. In some embodiments, the application of the internal energy storage circuit 292 is automatically selected by the controller 200 based on signals from the sensors 250, 270, 272, 274 or the battery pack 290, and the user does not need to select an application of the internal energy storage circuit 292.

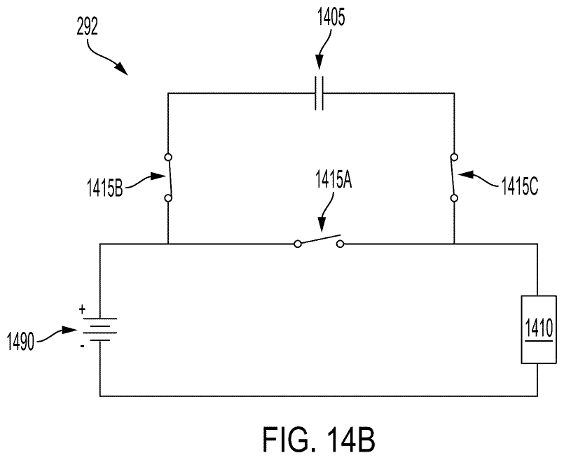

FIG. 14A and FIG. 14B illustrate a circuit schematic of any of the internal energy storage circuits described herein (e.g., internal energy storage circuit 292) operating in an OFF state and an ON state, respectively. In some embodiments, the internal energy storage circuit 292 includes a capacitor 1405 which is selectively connected in series to the battery pack 125 and load 1410 via three switches 1415A-1415C. The load 1410 may include, among other things, the switching network 255, the motor 280, and other electrical components of the power tool 100. In the illustrated embodiment, the capacitor 1405 is a low voltage ultra-capacitor (UCAP) capable of being charged to, for example, 14 volts, and the switches 1415A-1415C are electronically controllable switches capable of a conducting ON state and a non-conducting OFF state. In other embodiments not detailed herein, other types of capacitors with different device characteristics or other circuit elements, such as high power cells, may be used instead of ultra-capacitors as the internal energy storage circuit. Additionally, various types of switching elements, such as transistors, MOSFETs, BJTs, etc., may be used as the switches 1415A-1415C. The internal energy storage circuit 292 shown in FIGS. 14A-14B may be incorporated within either the housing 105 of the power tool 100 or external to the housing 105.

FIGS. 14A and 14B show an embodiment of the internal energy storage circuit 292 wherein the internal energy storage circuit 292 is a capacitor 1405 configured to be connected in series with the battery pack 1490 to power a load 1410. Referring to FIG. 14A, when switch 1415A is ON (closed) and switches 1415B and 1415C are OFF (open), the capacitor 1405 is disconnected from the battery pack 1490 and the load 1410. Thus, the internal energy storage circuit 292 is operating in the OFF state, and the battery pack 1490 is providing the power to drive the load 1410 without supplementary power from the capacitor 1405. Referring to FIG. 14B, when switch 1415A is OFF (open) and switches 1415B and 1415C are ON (closed), the capacitor 1405 is connected in series to the battery pack 1490 and load 1410. Thus, the internal energy storage circuit 292 is operating in the ON state (also referred to as a boost state), and the additional power provided by the capacitor 1405 supplements the power provided by the battery pack 1490 to drive the load 1410.

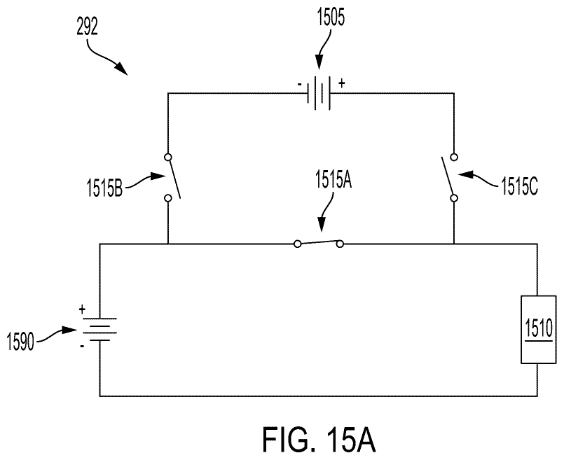

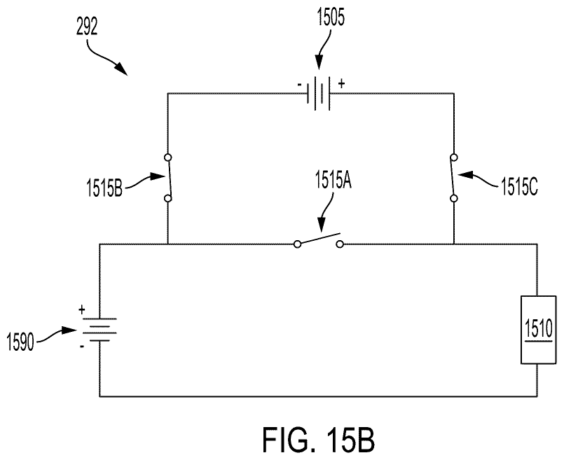

FIGS. 15A and 15B show an embodiment of any of the internal energy storage circuits described herein (e.g., internal energy storage circuit 292) wherein the internal energy storage circuit 292 is one or more battery cells 1505 configured to be connected in series with the battery pack 1590 to power a load 1510. Referring to FIG. 15A, when switch 1515A is ON (closed) and switches 1515B and 1515C are OFF (open), the one or more battery cells 1505 are disconnected from the battery pack 1590 and the load 1510. Thus, the internal energy storage circuit 292 is operating in the OFF state, and the battery pack 1590 is providing the power to drive the load 1510 without supplementary power from the one or more battery cells 1505. Referring to FIG. 15B, when switch 1515A is OFF (open) and switches 1515B and 1515C are ON (closed), the one or more battery cells 1505 is connected in series to the battery pack 1590 and load 1510. Thus, the internal energy storage circuit 292 is operating in the ON state, and the additional power provided by the one or more battery cells 1505 supplements the power provided by the battery pack 1590 to drive the load 1510.

In some embodiments, a bypass switch is provided in the circuits shown in FIGS. 14A, 14B, 15A, and 15B, so that the battery pack 1490 may be bypassed such that the load 1410 is driven by the capacitor 1405 alone, and similarly so that the battery pack 1590 may be bypassed such that the load 1510 may be driven by the one or more battery cells 1505 alone.

In some embodiments, by selectively connecting the internal energy storage circuit 292 with the battery pack 1490, 1590 and load 1410, 1510 in series, as opposed to in parallel, the internal energy storage circuit 292 is able to provide additional power to drive the load 1410, 1510 but may not need transformers for voltage matching or boost converters for voltage step-up. This simplifies the circuitry, increases the efficiency, and decreases the size of the power tool 100, relative to a parallel-connected internal energy storage circuit 292. Additionally, the series configuration of the internal energy storage circuit 292 may allow a higher voltage battery pack 290 and the one or more battery cells 1505 or a lower voltage capacitor 1405 to be used, thus decreasing the cost of manufacturing the power tool 100.

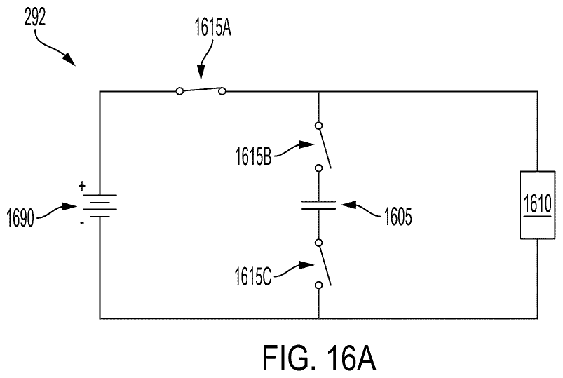

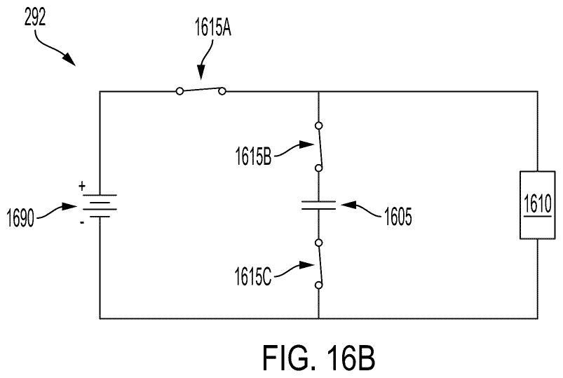

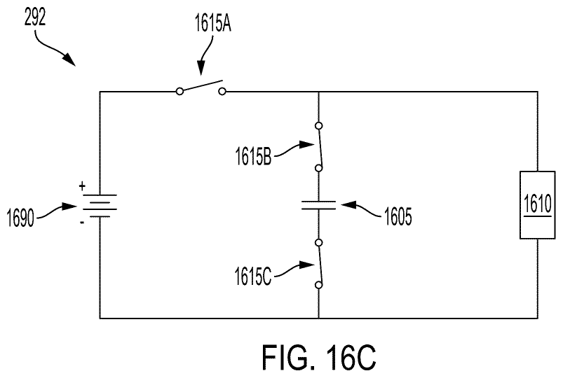

FIGS. 16A, 16B, and 16C show an embodiment of any of the internal energy storage circuits described herein (e.g., internal energy storage circuit 292) wherein the internal energy storage circuit 292 is a capacitor 1605 configured to be connected in parallel with the battery pack 1690 to power a load 1610. Referring to FIG. 16A, when switch 1615A is ON (closed) and switches 1615B and 1615C are OFF (open), the capacitor 1605 is disconnected from the battery pack 1690 and the load 1610. Thus, the internal energy storage circuit 292 is operating in the OFF state, and the battery pack 1690 is providing the power to drive the load 1610 without supplementary power from the capacitor 1605. Referring to FIG. 16B, when switch 1615A is ON (closed) and switches 1615B and 1615C are ON (closed), the capacitor 1605 is connected in parallel to the battery pack 1690 and load 1610. Thus, the internal energy storage circuit 292 is operating in the ON state, and the additional power provided by the capacitor 1605 supplements the power provided by the battery pack 1690 to drive the load 1610. Referring to FIG. 16C, when switch 1615A is OFF (open) and switches 1615B and 1615C are ON (closed), the capacitor 1605 alone provides power to drive the load 1610, without any power provided from the battery pack 1690.

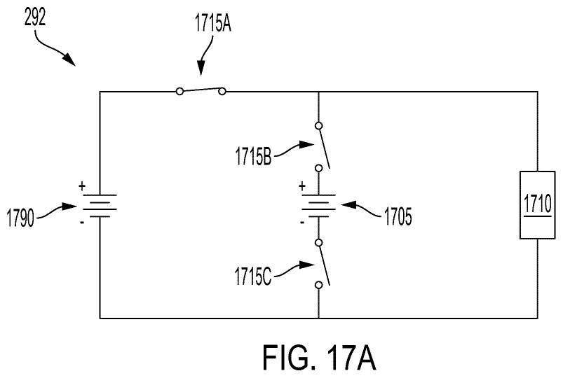

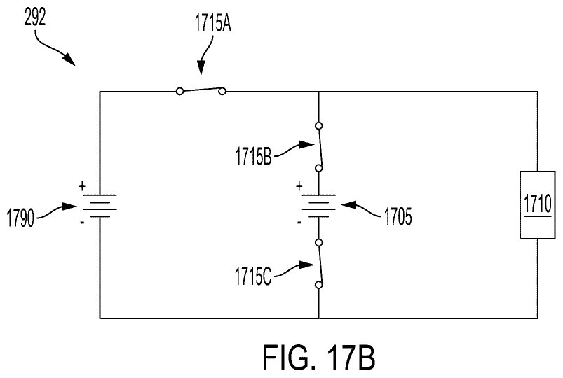

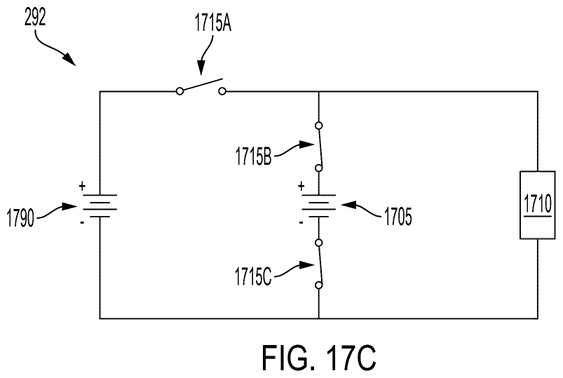

FIGS. 17A, 17B, and 17C show an embodiment of any of the internal energy storage circuits described herein (e.g., internal energy storage circuit 292) wherein the internal energy storage circuit 292 is one or more battery cells 1705 configured to be connected in parallel with the battery pack 1790 to power a load 1710. Referring to FIG. 17A, when switch 1715A is ON (closed) and switches 1715B and 1715C are OFF (open), the one or more battery cells 1705 are disconnected from the battery pack 1790 and the load 1710. Thus, the internal energy storage circuit 292 is operating in the OFF state, and the battery pack 1790 is providing the power to drive the load 1710 without supplementary power from the one or more battery cells 1705. Referring to FIG. 17B, when switch 1715A is ON (closed) and switches 1715B and 1715C are ON (closed), the one or more battery cells 1705 are connected in parallel to the battery pack 1790 and load 1710. Thus, the internal energy storage circuit 292 is operating in the ON state, and the additional power provided by the one or more battery cells 1705 supplements the power provided by the battery pack 1790 to drive the load 1710. Referring to FIG. 17C, when switch 1715A is OFF (open) and switches 1715B and 1715C are ON (closed), the one or more battery cells 1705 alone provide power to drive the load 1710, without any power provided from the battery pack 1790.

In some embodiments, by selectively connecting the internal energy storage circuit 292 with the battery pack 1690, 1790 and load 1610, 1710 in parallel, as opposed to in series, the internal energy storage circuit 292 is able to provide additional power to drive the load 1610, 1710 for a comparatively longer period. Additionally, if the internal energy storage circuit 292 includes a cluster of units (e.g., cluster of units 1393B) the parallel connection allows the malfunction or failure of at least one of the units without causing an interruption in the operation of the power tool 100.

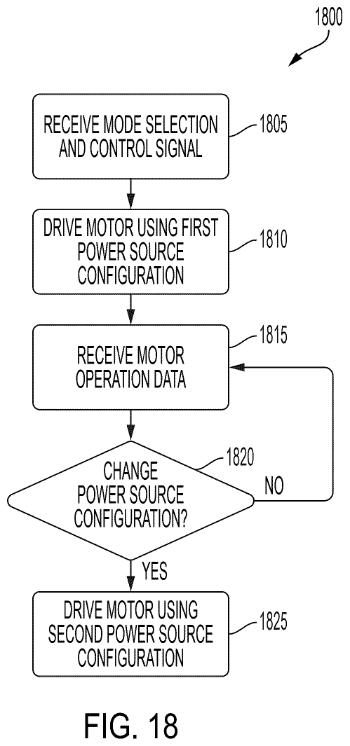

FIG. 18 is a flowchart illustrating a control method for providing auxiliary power to a battery pack powered power tool based on operation parameters of the tool. In some embodiments, method 1800 is implemented with one of the embodiments of the power tool 100 of FIG. 1 and, accordingly, the method 1800 will be described with respect to the power tool 100 and a series configuration of the internal energy storage circuit 292. However, in some embodiments, the method 1800 is implemented with other types of power tools and power source configurations, as described above.

In block 1805, the controller 200 receives a control signal (e.g., a trigger pull signal) from the user interface 212 (e.g., trigger 115) indicating a request to drive the motor 280. The controller 200 also receives a selection of a desired application of the internal energy storage circuit 292 via the mode selector 140. In some embodiments, the selection of a desired application by a user is optional.

In block 1810, in response to the received control signal and selection of the desired application of the internal energy storage circuit 292, the controller 200 drives the motor 280 or load (e.g., load 1710) using a first power source configuration. For example, power from either the battery pack 125 or the internal energy storage circuit 292, or both, are used to drive the motor 280 to drive the output shaft 130. For example, in response to the received control signal and application selection, the controller 200 may selectively enable and disable the switching network 255 to selectively apply power from only the battery pack 125 to stator windings of the motor 280, thus driving the motor 280 or load and the output shaft 130. In such a case, the controller 200 controls the internal energy storage circuit 292 to be disconnected the internal energy storage circuit 292 from the battery pack 125 and motor 280 or load by controlling internal energy storage circuit inclusion switches that are configured to either include or exclude the internal energy storage circuit 292 from supplying power to the motor 280 or load (e.g., switches 1415B, 1415C, 1515B, 1515C, 1615B, 1615C, 1715B, or 1715C) to be OFF. The controller 200 also controls battery pack inclusion switches that are configured to either include or exclude the battery pack 125 from supplying power to the motor 280 or load (e.g., switches 1415A, 1515A, 1615A, on 1715A) to be ON to connect the battery pack 125 to the motor 280 or load.

In block 1815, while the motor 280 is being driven, the controller 200 receives motor operation data provided from at least one of the sensors 250, 270, 272, 274. In various embodiments not exhaustively described herein, the sensors 250, 270, 272, 274 may be current sensors that detect a current drawn by the motor 280, Hall Effect sensors that detect a rotational position, velocity, or acceleration of the motor 280, or a combination of different types of sensors configured to measure various motor operation characteristics and provide motor operation data indicative of the measured characteristics to the controller 200. As described above, the controller 200 can make a determination of if and how to change the configuration of the battery pack 125 and the internal energy storage circuit 292 to drive the motor 280 or load.

In block 1820, based on the received motor information, or based on the selection of a desired application of the internal energy storage circuit 292, or both, the controller 200 determines whether to change the power source configuration to, for example, provide additional power from the internal energy storage circuit 292 or to provide power from the internal energy storage circuit 292 only. For example, in some embodiments, the received motor operation data includes motor current, and the controller 200 compares the motor current to a current threshold in block 1820. In response to the motor current exceeding the current threshold, the controller 200 may automatically (without user selection) provide additional power from the internal energy storage circuit 292 to the motor 280 and advances to block 1825. In response to the motor current being below the current threshold, the controller 200 may automatically determine not to provide additional power from the internal energy storage circuit 292 and returns to block 1815.

In block 1820, when the controller 200 determines not to change the power source configuration, blocks 1815-1820 are repeated while the motor continues to be driven. On the other hand, in block 1820, when the controller 200 determines to change the power source configuration, the method 1800 proceeds to block 1825 and, for example, connects the internal energy storage circuit 292 in series with the battery pack 125 to provide additional power to the motor 280. For example, to implement block 1825, the controller 200 activates the internal energy storage circuit 292 by controlling the position of switches (e.g., switches 1415A, 1415B, 1415C, 1515A, 1515B, 1515C, 1615A, 1615B, 1615C, 1415A, 1715B, or 1715C) to connect the internal energy storage circuit 292 to the battery pack 125 and load (e.g., motor 280) in series such that the additional power discharging from the internal energy storage circuit 292 adds to the power provided by the battery pack 125 to drive the motor 280.

In some embodiments, the internal energy storage circuit 292 is connected in parallel with the battery pack 125 to drive the motor 280 or load based on a selection of a desired application of the internal energy storage circuit 292 made by a user of the power tool 100 via mode selector 140 and/or based on motor operation data. In other embodiments, the internal energy storage circuit 292 alone is used to drive the motor 280 or load based on a selection of a desired application of the internal energy storage circuit 292 made by a user of the power tool 100 via mode selector 140 and/or based on motor operation data or based on an indication that the battery pack 290 is not connected to the battery pack interface 285. In some embodiments, the determination of if and how to change the configuration of the battery pack 125 and the internal energy storage circuit 292 to drive the motor 280 or load or described herein is made automatically by the controller 200, without user selection.

Thus, embodiments described herein provide, among other things, an internal energy storage circuit in a battery pack powered power tool that provides auxiliary power to a load of the power tool and a control method of providing said auxiliar power based on motor operational data and/or a user selected internal energy storage circuit application for a battery-powered power tool. Various features and advantages are set forth in the following claims.

We claim:

1. A power tool comprising:
a power tool housing;
an interface configured to receive a battery pack;
an internal energy storage circuit located within the power tool housing;
a trigger for user control of power tool operation;
a plurality of switches configured to connect the battery pack and the internal energy storage circuit in series or parallel; and
a controller configured to:
receive a control signal from the trigger,
control the power tool based on the control signal,
control the plurality of switches to set a power source configuration of the power tool by selectively connecting the battery pack, the internal energy storage circuit, or both the battery pack and the internal energy storage circuit to a load of the power tool; and
provide energy to the load of the power tool according to the power source configuration.

2. The power tool of claim 1, further comprising:
a sensor configured to measure an operational characteristic of the power tool,
wherein the controller is further configured to receive power tool operational data from the sensor indicative of the operational characteristic of the power tool, and
wherein, to provide energy to the load, the controller is further configured to provide additional energy to the load via the internal energy storage circuit based on the operational characteristic.

3. The power tool of claim 2, wherein the power source configuration is set automatically by the controller.

4. The power tool of claim 1, wherein the controller is further configured to increase a voltage provided to the load of the power tool by connecting the internal energy storage circuit in series with the battery pack.

5. The power tool of claim 1, wherein the internal energy storage circuit has a higher voltage than the battery pack.

6. The power tool of claim 5, wherein the internal energy storage circuit includes a capacitor.

7. The power tool of claim 1, further comprising:
a mode selector,
wherein the power source configuration is based on a selection of a desired application of the internal energy storage circuit made using the mode selector.

8. An electrical device comprising:
an internal energy storage circuit;
a plurality of switches configured to connect a battery pack and the internal energy storage circuit in series or parallel; and
a controller configured to:
control the plurality of switches to set a power source configuration of a power tool by selectively connecting the battery pack, the internal energy storage circuit, or both the battery pack and the internal energy storage circuit to a load of the power tool; and
provide energy to the load of the power tool according to the power source configuration.

9. The electrical device of claim 8, further comprising:
a sensor configured to measure an operational characteristic of the power tool,
wherein the controller is further configured to receive power tool operational data from the sensor indicative of the operational characteristic of the power tool, and
wherein, to provide energy to the load, the controller is further configured to provide additional energy to the load via the internal energy storage circuit based on the operational characteristic.

10. The electrical device of claim 9, wherein the power source configuration is set automatically by the controller.

11. The electrical device of claim 8, wherein the controller is further configured to increase a voltage provided to the load of the power tool by connecting the internal energy storage circuit in series with the battery pack.

12. The electrical device of claim 8, wherein the internal energy storage circuit has a higher voltage than the battery pack.

13. The electrical device of claim 12, wherein the internal energy storage circuit includes a capacitor.

14. The electrical device of claim 8, further comprising:
a mode selector,
wherein the power source configuration is based on a selection of a desired application of the internal energy storage circuit made using the mode selector.

15. A method of providing auxiliary power to a battery pack powered power tool based on operation parameters of a power tool, the method comprising:
controlling, via a controller of the power tool, a plurality of switches to connect a battery pack and an internal energy storage circuit of a power tool in series or parallel;
controlling, via the controller, the plurality of switches to set a power source configuration of the power tool by selectively connecting the battery pack, the internal energy storage circuit, or both the battery pack and the internal energy storage circuit to a load of the power tool; and
providing, via the power source configuration, energy to the load of the power tool.

16. The method of claim 15, further comprising:
receiving, via the controller, power tool operational data from a sensor indicative of an operational characteristic of the power tool,
wherein, to provide energy to the load, the controller is further configured to provide additional energy to the load via the internal energy storage circuit based on the operational characteristic.

17. The method of claim 16, wherein the power source configuration is set automatically by the controller.

18. The method of claim 15, further comprising:
increasing, via the controller, a voltage provided to the load of the power tool by connecting the internal energy storage circuit in series with the battery pack.

19. The method of claim 15, wherein the internal energy storage circuit has a higher voltage than the battery pack.

20. The method of claim 15, further comprising:
setting, via the controller, the power source configuration is based on a selection of a desired application of the internal energy storage circuit made using a mode selector of the power tool.
